(19) United States
(12) Patent Application Publication
(10) Pub. No.: US 2005/0053777 A1
(43) Pub. Date: Mar. 10, 2005

(54) Pellicle

(76) Inventor: Donald Bennett Hilliard, Tucson, AZ (US)

Correspondence Address: Hilliard, Donald B., 3050 North Fontana Ave., Tucson, AZ, 85705, US

(21) Appl. No.: 10/936,257

(22) Filed: Sep. 7, 2004

Related U.S. Application Data
(60) Provisional application No. 60/500,837, filed on Sep. 6, 2003.

(51) Int. Cl. B32B 7/02; B32B 27/00; B32B 31/00

(52) U.S. Cl. 428/212; 428/411.1; 427/407.1

(57) ABSTRACT

A polymer-based pellicle structure is disclosed for incorporation into electro-optic modulators used in testing of electronic devices, such as devices incorporated in flat panel displays. The pellicle structure comprises a polymer pellicle base, a dielectric reflector deposited onto the base, the dielectric reflector comprising alternating layers of organic and inorganic dielectric materials. The disclosed pellicle structure provides numerous advantages over the prior art. When the disclosed pellicle structure is terminated with a polymer layer, the propensity for tearing or damage to the pellicle or the tested device is significantly ameliorated, due to the relative softeness, toughness, and much higher elasticity of the polymer over prior art inorganic compounds used for the same application. Other advantages related to production costs, and advantageous properties provided by the polymer layer are also disclosed.

This application is related to U.S. Provisional Appl. No. 60/500,837.

### TECHNICAL FIELD

The present invention relates generally to the field of optical testing of flat-panel displays, and, in particular, to pellicle devices used in the implemantation thereof.

### BACKGROUND ART

The testing of the electronic devices that are incorporated in flat panel displays is commonly conducted by way of optical interrogation of flat panel devices by use of optical radiation that is reflected from the surface of a reflective layer. The reflective layer resides between the remainder of an electro-optic modulator from the device surface being tested by a very small clearance, typically on the order of microns. Such subject matter is disclosed in patents U.S. Pat. No. 6,151,153, U.S. Pat. No. 6,211,991, U.S. Pat. No. 5,771,068, U.S. Pat. No. 5,764,209, U.S. Pat. No. 5,750,981, U.S. Pat. No. 5,615,039, U.S. Pat. No. 5,504,438, and in the references thereof. In such prior art, an electro-optic element is employed, wherein the element senses voltage fields from an underlying device under test, such as a pixel electrode of a flat panel display. Such electro-optic elements require a reflective layer between an electro-optic material and the device under test. This reflective layer is typically formed on a polymer film, the reflective layer and polymer film thus comprising a thin pellicle material that both provides the required reflectivity, as well as the outer-most surface exposed to the device under test. The pellicle must also be quite thin to allow a susceptibility of the testing medium, which resides on the opposite side of the pellicle from the tested device, to register the presence of an electric field produced by a surface of the tested device. Such methods and structures have been successfully commercialized.

Previous pellicles utilized for testing utilize a dielectric reflector, the reflector composed of inorganic layers of different refractive index for providing the required reflectivity. The inorganic layers each comprise a nominal quarter-wave optical thickness for providing reflective properties, as is well known and practiced in the art of optical filters. Such inorganic layers typically comprise such metal oxide compounds as are commonly found in the art of dielectric reflectors, e.g., zirconia, silica, alumina, titania, hafnia, niobium oxide, etc.

A variety of methods are disclosed in the prior art for fabricating alternating layers of organic and inorganic layers onto polymer substrates. Such methods are well-described in the art of polymer multilayers (PML), particularly in field of transparent environmental barriers, wherein transparent polymeric and inorganic layers of different refractive index are deposited onto a flexible substrate to produce a multilayer structure of alternating organic and inorganic layers. In particular, methods, materials, and apparatus used for fabrication of reflective PML layers, onto polymer materials that are typically utilized in pellicle manufacture, may be found in U.S. Pat. No. 6,268,695, U.S. Pat. No. 6,413,645 and U.S. Pat. No. 6,522,067, U.S. Pat. No. 6,503,634, U.S. Pat. No. 6,503,634, US05686360, US05757126, US05757126, US06413645, US06413645, US06497598, and US06497598.

As is common in the industrial use of pellicle materials, the pellicle materials used herein are typically mounted on a support frame. Mounted pellicle fabrication is a well-developed art, and many methods and apparatus for the fabrication of mounted pellicles have been laid out in the prior art. Such methods and apparatus are disclosed in, for example, issued patents, U.S. Pat. No. 5,576,125, U.S. Pat. No. 5,597,669, U.S. Pat. No. 5,723,860, U.S. Pat. No. 5,769,984, U.S. Pat. No. 5,772,817, U.S. Pat. No. 5,814,381, U.S. Pat. No. 6,300,019, and U.S. Pat. No. 6,303,196. Pellicles used in many optical applications are typically coated with additional layers. In prior art pellicle manufacturing, the pellicle membrane may be mounted to the pellicle frame before or after a coating is applied to the membrane material.

Difficulties exist in the industry for testing flat panel displays. In the case that the reflector layer is disposed on the outside surface of the pellicle, so as to be directly exposed to the device under test, all-inorganic dielectric reflectors utilized in the testing pellicle will exacerbate interference with various protrusions and particles that may exist on the device being tested. Such interference will result in tearing of the testing pellicle and a subsequent downtime in the testing process for exchange of the torn pellicle with a new pellicle. In addition, the interference of the pellicle surface with such protusions and particles can result in a damaging effect on the device being tested, which incurs additional unneeded costs.

Alternatively, if the reflective layer is disposed on the inside surface of the pellicle, so that the reflective layer contacts the electro-optic material, then difficulties can arise from either mechanical or chemical interactions between the electro-optic material and the inorganic materials of the reflective layer. Such undesirable interaction can be increased as a result of the reflective layer comprising materials that are not completely dense on a nanometer scale, which is very difficult to avoid in inorganic films deposited onto polymer films. These difficulties are in addition to difficulties associated with obtaining reproducible inorganic reflectors on polymer films, which are well-known for possessing particulates, surface inhomogeneities, and an overall high density of microscopic defects.

### DISCLOSURE OF INVENTION

In accordance with the preferred embodiments of the invention, a pellicle structure is disclosed, the pellicle for use in the optical testing of flat panel displays. The disclosed pellicle structure utilizes a novel polymer/inorganic composite structure that provides several advantages over prior art pellicles used in optical testing of flat panel displays. The disclosed pellicle comprises a polymer pellicle base, a dielectric reflector deposited onto the base, the dielectric reflector comprising alternating layers of organic and inorganic dielectric materials. Preferable the dielectric reflector is terminated by a polymer layer, so that subsequent use of the pellicle for testing devices will not result in unfavorable interactions between inorganic reflector materials and other media in the testing environment.

The disclosed pellicle is not limited to use in the testing of devices related to the flat panel display industry, as it may as readily be used for the testing of other device structures wherein the use of polymer characteristics in the reflecting layer may be similarly advantageous.

One advantage of the present invention is that it provides a relatively elastic reflective coating to the pellicle, thereby reducing damaging effects to the tested device, due to particles chafing between the pellicle and the tested device.

Another advantage of the present invention is that it provides a relatively elastic reflective polymer top coating to the pellicle, thereby resulting in a more robust pellicle structure and longer pellicle service-lifetime when the pellicle is incorporated in an electro-optic test module.

Another advantage of the present invention is that it provides a reflective coating that is inherently less prone to intrinsic mechanical stress or strain, making it less susceptible to modification when the coating is in contact with modulator materials.

Another advantage of the present invention is that it provides a relatively elastic reflective polymer top coating to the pellicle, thereby resulting in a more pellicle structure that can withstand greater fluctuations in humidity.

Another advantage of the present invention is that it provides a relatively elastic reflective polymer top coating to the pellicle, thereby resulting in a more pellicle structure that can withstand greater fluctuations in temperature.

Yet another advantage of the invention is that it allows for the use of thinner pellicle material in the pellicle.

Another advantage of the present invention is that is allows for significantly higher production rates and lower cost of production over previous all inorganic dielectric stacks used in prior art pellicles used for testing flat panel displays.

Another advantage of the present invention is that it provides a dielectric reflector that, when deposited to provide a polymer smoothing layer as the first layer contacting the polymer substrate, allows for various imperfections and unwanted features of the polymer substrate to be substantially eliminated for the intended application of optical testing.

Yet another advantage of the invention is that it allows for termination of the pellicle with a polymer surface that may allow advantageous triboelectric properties that are not possible using conventional inorganic surface termination.

Yet another advantage of the invention is that it allows for termination of the pellicle with a polymer surface that may allow advantageous tribological properties that are not possible using conventional inorganic topcoats.

Another advantage of the present invention is that the material properties may be selected for low-k properties not possible using conventional inorganic topcoats.

Other objects, advantages and novel features of the invention will become apparent from the following description thereof. In the accompanying drawings, like numerals correspond to like elements.

### BRIEF DESCRIPTION OF THE DRAWINGS

FIG. 1a (Prior Art) is an electro-optic modulator element of the prior art.

FIG. 1b (Prior Art) is a perspective view of a pellicle of the prior art.

FIG. 1c (Prior Art) is an electro-optic modulator element of the prior art, in a testing environment.

FIG. 2 is a cross-section of the invented pellicle structure in its first preferred embodiment.

FIG. 3 is a an alternative embodiment of the disclosed pellicle structure.

FIG. 4 provides a perspective (a) and a sectional view (b) of the apparatus used for cooling the pellicle during deposition of a reflecting coating.

### DESCRIPTION OF THE PREFERRED EMBODIMENTS

List of Elements

pellicle support structure (1)

reflective coating (2)

polymer-based film (3)

low-index material layer (4)

high-index material layer (5)

first deposited layer (7)

last deposited layer (8)

low/high index dyad (9)

cooled platen (14)

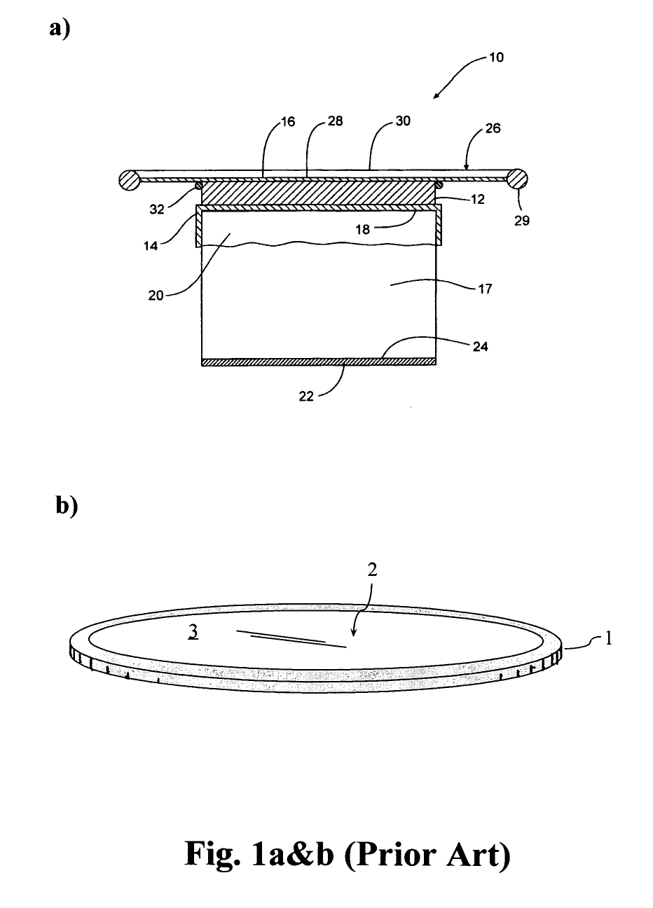

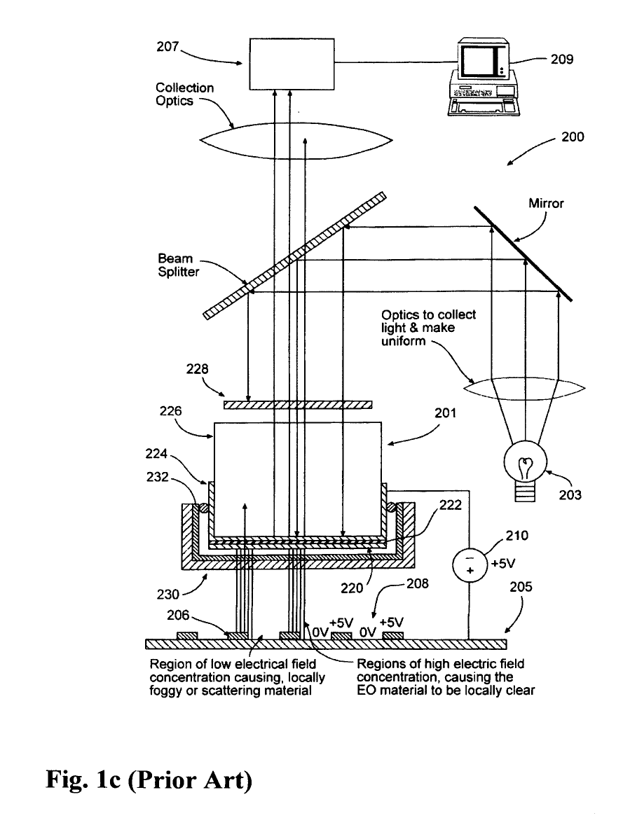

The following description and FIGS. 1-4 of the drawings depict various embodiments of the present invention. The embodiments set forth herein are provided to convey the scope of the invention to those skilled in the art. While the invention will be described in conjunction with the preferred embodiments, various alternative embodiments to the structures and methods illustrated herein may be employed without departing from the principles of the invention described herein.

(PRIOR ART) FIG. 1a is a cross-sectional view diagram of an electro-optical element 10 of the prior art, as referenced from U.S. Pat. No. 6,151,153. The electro-optic assembly includes electro-optical modulator material 12, transparent electrode 14, anti-reflective layer 22, substrate 17, top surface 18, four edges 20 of the substrate, bottom surface 24. The electro-optic element includes a pellicle assembly 26, which includes a support structure 29 having a film of plastic 30 disposed thereon. A reflective layer 16 is deposited on plastic 30. A thin film or bead 32 of adhesive is applied to a periphery of the electro-optical material to seal it to reflective layer 16.

(PRIOR ART) In the optical testing of flat panel display devices by electro-optic means, pellicle assemblies of the prior art, in FIG. 1b, have utilized a support structure (1), typically a ring, that suspends a polymer-based film (3) that is coated with an all-dielectric reflector comprising various inorganic compounds common to the manufacture of such dielectric reflectors. As such, the reflective coating (2) comprises a series of, typically metal oxide, inorganic layers that possess physical properties commensurate with such compounds; e.g., relatively high hardness, low elasticity, low fracture-resistance, and relatively high k values.

(PRIOR ART) FIG. 1c is a diagram of test equipment 200 with an electro-optical element of the prior art, as referenced from U.S. Pat. No. 6,151,153, comprising electro-optical element 201, electro-optical modulator material 220, adhesive layer 222, electrode 224, a substrate 226, light source 203, active matrix liquid crystal display 205, pixel elements 206, inactive regions 208, voltage 210, camera 207, monitor 209, an anti-reflective coating 228, and a pellicle assembly 230. In this figure, the reflective layer 232 is disposed on the inside surface of the pellicle assembly 230. It is noted that the reflector 232 may also be disposed on the outside surface of the pellicle assembly 230.

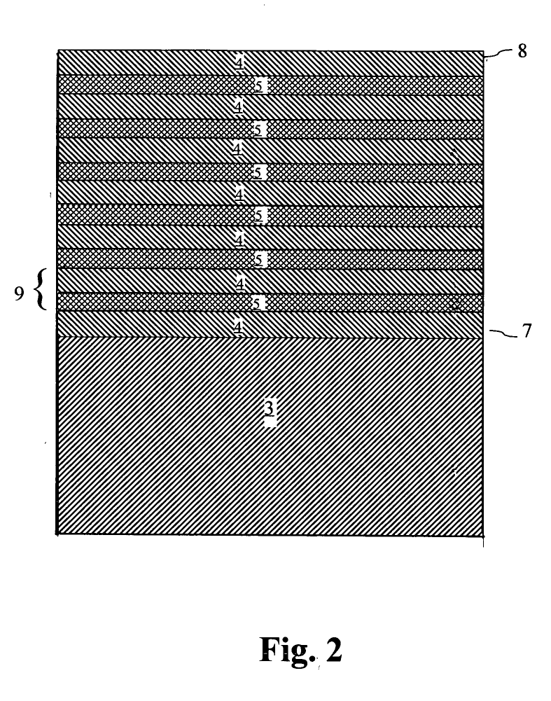

In accordance with the preferred embodiments of the invention, the disclosed pellicle utilizes a reflective coating that comprises alternating material layers of different refractive indices, wherein at least one of the alternating material layers is a polymer. As in the case of prior art all-dielectric reflectors, the reflective coating of the present invention requires at least two different materials to form the alternating refractive indices required for interference-based reflection. Accordingly, the disclosed structure includes a low-index material (4), and a high-index material (5), which are deposited in alternating sequence to form dyads, or layer pairs, such as the two-layer dyad (9) of FIG. 2, of low and high-index layers, whereby a reflectivity is obtained. While the reflector structure of the present invention is preferred to possess in the range of three to eight layer pairs (9), it may be advantageous to have less, or many more layer pairs than this range, under certain circumstances. The reflective coating and polymer substrate, in FIG. 2, are preferably deposited with at least the first deposited layer (7) and last deposited layer (8) comprising a polymer-based material. In this way, the first deposited layer (7), when it is an organic material, may be utilized to mask imperfections in the substrate, whereas the last deposited layer (8), when it is an organic material, may be utilized to provide a damage-resistant top-coat for subsequent use in the testing applications intended. Also, it is foreseen that the most economical embodiment of the invention is a dielectric reflector wherein all layers of low refractive index are a polymer layer. Alternatively, in the latter case, wherein only the low-index layers are organic material, it may in some cases be found advantageous to have either or both of the first deposited (7) and last deposited (8) layers be a high-index inorganic material, rather than a low-index organic, in FIG. 2, since terminating the all-dielectric reflector with high-index layers is known to increase reflectivity.

In some instances, it may be preferable to fabricate the dielectric reflector with only one layer or selected layers as an organic and the remaining layers as inorganics. For example, it may be preferable in some applications, that only the first deposited layer (7) is an organic layer, or, alternatively, that only the last deposited layer (8) is an organic layer. It is also typically preferable that the low-index material comprises an organic material, since low-index polymers are more readily available, whereas, the high-index material (5) is readily formed from inorganic materials. However, any layer or layers of the all-dielectric reflector of the present invention may comprise an organic material.

The pellicle frame will typically be removed from the electro-optic modulator before actual use, and the frame is only utilized in the prior art and herein as a preferred means of processing and transferring the pellicle material to the electro-optic modulator assembly. Accordingly, the pellicle frame may not be required for obtaining the benefits and advantages of the present invention. In fact, increased flexibility and elasticity provided by the presently disclosed reflective layer may, in some instances, be sufficient to also allow the coated polymeric film of the present invention to be transferred without the use of a pellicle frame.

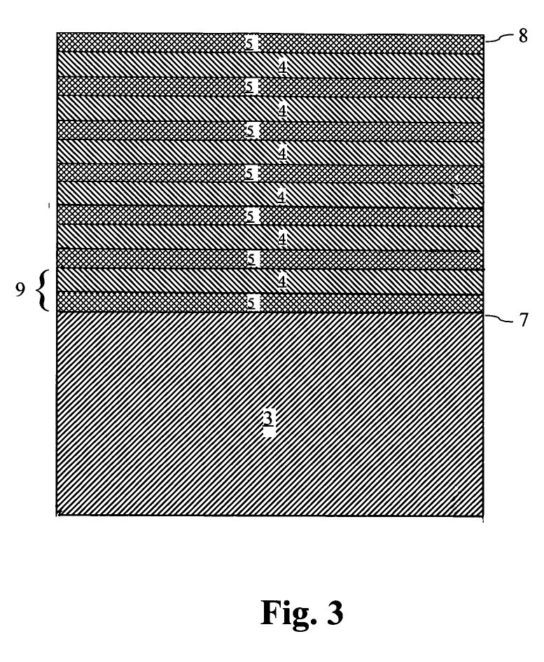

An alternative embodiment of the invention, in FIG. 3, utilizes an all-organic dielectric reflector. In the embodiments of FIG. 3, the dielectric reflector comprises alternating layers of polymer materials to provide the required reflectivity. Of course, the disclosed reflective coating may be integrated into a larger thin film structure, wherein additional layers are deposited for providing additional functionality.

In the case that the reflective coating comprises alternating layers of substantially organic and substantially inorganic materials, it may be possible to achieve greater fracture-resistance and flexibility in the resulting reflective structure by incorporating small amounts of organic in the inorganic layer, while still retaining high index properties that inorganic materials offer. Likewise, it may be possible to incorporate inorganic particles, ligands, etc., into the substantially organic layers, without losing the advantages offered by the organic materials used. Such modifications may therefore be employed without departing from the spirit or principles of the invention set forth herein.

The polymer materials utilized in the presently disclosed dielectric reflector may comprise any of a variety of polymers used in previous polymer multilayer structures. Also, the deposition methods for depositing these polymer materials may vary considerably, and are exhaustively covered in other industries—namely in the field of thin film polymers. Proven polymer materials formed into polymer thin films include various methods, but in the first preferred embodiments, comprise deposition of a liquid monomer onto the substrate by such method as evaporation, the monomer subsequently cured by a curing technique of the prior art, such as e-beam or ultraviolet curing. The particular cure method utilized under particular circumstances will depend on the specific choice of monomer materials and the layer thickness used, amongst other variables. Accordingly, a variety of monofunctional and multifunctional acrylate and methacrylate monomers, which are discussed in the prior art references, and may be identified by reference to the Sartomer catalog, for example, may be utilized as the deposited monomer.

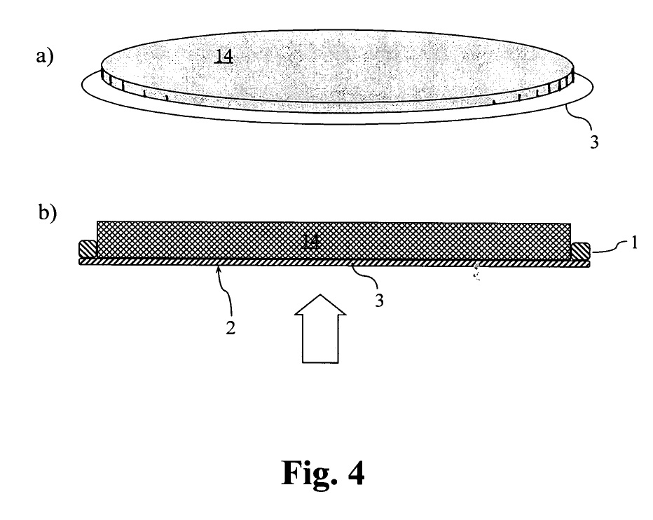

While it is expedient to fabricate the disclosed pellicle from polymer films that have been already coated with the reflecting layer by the PML methods of the prior art, it is understood that the pellicle may be formed by any methods available. For example, the supported polymer film may be coated with the reflector after it is mounted on the pellicle frame, as is frequently done in the semiconductor industry, for optical pellicles used in lithography. Depending on the deposition method and curing methods used for depositing the organic layers of the present invention, it may be preferable to mount the pellicle substrate that comprises the suspended polymer film and suspending structure, onto cooled substrate fixturing comprising a cooled platen (14), in FIG. 4, whereby the back of the polymer film may be cooled by a cooled material surface during deposition and curing. The cooling surface may be a metal platen that is flattened to the approximate flatness of the suspended polymer film (3), so that gas or contact cooling may be utilized between the cooled surface and the suspended polymer material. The broad arrow in FIG. 4 indicates the deposition direction for condensation of material onto the suspended polymer (3) to create the reflective coating (2). Such methods are well-known and commonly practiced for rotating drum surfaces in the web-coating of polymer films. Such a cooling surface may also be implemented in the deposition of the inorganic materials, as well, so that throughput for fabrication of the pellicle structures may be increased.

In addition, the utilization of a cooling surface behind the suspended polymer during the deposition of the reflecting coating, as in FIG. 4, allows for the ability to control thermal expansion of materials during the deposition process, which in turn allows for greater control over the resultant properties of the coated pellicle.

Various polymer materials may be utilized for either the suspended polymer (3) or the layer materials (4,5) depending on the specific requirements of the particular application. For instance, if tribological properties are of primary concern, it may then be preferred that that the terminating polymer layer of the disclosed dielectric reflector, that layer immediate to the tested flat panel, be composed of a fluorinated polymer for obtaining a low friction characteristic at the surface of the dielectric reflector exposed to the tested device.

Formation of PML structures may be accomplished by a variety of means; however, in the preferred embodiments of the present invention, the PML structures is formed by vacuum vapor deposition methods and apparatus readily available in prior art manufacturing processes. Accordingly, the PML structures of the present invention may be formed utilizing a variety of prior art vapor sources for the PML material. The inorganic vapor source may comprise any appropriate source of the prior art, including but not limited to sputtering, evaporation, electron-beam evaporation, chemical vapor deposition (CVD), plasma-assisted CVD, etc. The monomer vapor source may similarly be any monomer vapor source of the prior art, including but not limited to flash evaporation, boat evaporation, Vacuum Monomer Technique (VMT), polymer multilayer (PML) techniques, evaporation from a permeable membrane, or any other source found effective for producing a monomer vapor. For example, the monomer vapor may be created from various permeable metal frits, as previously in the art of monomer deposition. Such methods are taught in U.S. Pat. No. 5,536,323 (Kirlin) and U.S. Pat. No. 5,711,816 (Kirlin), amongst others.

Although the present invention has been described in detail with reference to the embodiments shown in the drawing, it is not intended that the invention be restricted to such embodiments. It will be apparent to one practiced in the art that various departures from the foregoing description and drawing may be made without departure from the scope or spirit of the invention.

1. A pellicle for the electro-optical testing of devices, the structure comprising:
a.) a polymer film;
b.) a reflective coating deposited on the surface of the polymer film, the reflective coating comprising alternating material layers of differing refractive index, at least one of the material layers comprising an organic material.

2. The pellicle structure of claim 1, wherein the devices are flat panel displays.

3. The pellicle structure of claim 1, wherein the organic forms a smoothing layer.

4. The pellicle structure of claim 1, wherein the organic material forms a topcoat.

5. The pellicle structure of claim 1, wherein the organic material is fluorinated.

6. The pellicle structure of claim 1, wherein the organic material is a substantially cured polymer.

7. The pellicle structure of claim 6, wherein the polymer contains some trace inorganic material.

8. The pellicle structure of claim 6, wherein the polymer contains some trace inorganic material.

9. An improved electro-optic modulator assembly, comprising:
a.) an electro-optic layer disposed onto an optical substrate;
b.) a pellicle layer disposed over the electro-optic layer, the pellicle comprising a polymer film, a reflective coating deposited onto the polymer film, the reflective coating including an organic layer.

10. A process for forming a reflective pellicle structure for testing electronic devices, comprising the steps:
a.) placing a pellicle over a water-cooled platen, so that the pellicle material is cooled by the platen;
b.) forming a substantially polymerized layer over the pellicle material, the polymerized layer formed by depositing and curing a monomer;
c.) depositing an inorganic material over the polymerized layer, thereby forming a substantially inorganic layer;
d.) depositing and curing a second monomer layer, so that an optically reflective coating is formed, the coating comprising alternating layers of different refractive index, wherein increased mproved mechanical properties are achieved.
